(19) United States
(12) Patent Application Publication
(10) Pub. No.: US 2007/0284910 A1
(43) Pub. Date: Dec. 13, 2007

(54) MOVABLE VEHICLE ROOF ASSEMBLY

(75) Inventor: Gernot Bruder, Karlsruhe (DE)

Correspondence Address: BROOKS KUSHMAN P.C., 1000 TOWN CENTER, TWENTY-SECOND FLOOR, SOUTHFIELD, MI, 48075, US

(73) Assignee: Magna Car Top Systems GmbH, Bietigheim-Bissingen (DE)

(21) Appl. No.: 11/743,886

(22) Filed: May 3, 2007

(30) Foreign Application Priority Data
May 3, 2006 (DE) 10 2006 020 759.9

(51) Int. Cl. B60J 7/08

(52) U.S. Cl. 296/107.02

(57) ABSTRACT

A vehicle includes a roof having roof parts, a roof kinematic system, and a transmission kinematic system. The roof parts are movable between a closed position covering the vehicle interior and a stored position exposing the vehicle interior. The roof kinematics system has a guide rod pivotably supported about a vehicle body-side rotary joint and pivotably supported to a roof part to movably connect the roof part to the vehicle such that upon actuation of the rod the roof kinematic system moves the roof part. The transmission kinematic system has a spring and a displaceable tensioning lever. The spring is connected to the rod and the lever. When the spring is pretensioned the spring acts upon the rod with a swivel torque about the rotary joint to actuate the rod to move the roof part. The lever places the spring under pretension upon being displaced.

### CROSS-REFERENCE TO RELATED APPLICATIONS

This application claims foreign priority benefits under 35 U.S.C. § 119(a)-(d) to DE 10 2006 020 759.9, filed May 3, 2006, which is hereby incorporated by reference in its entirety.

### BACKGROUND OF THE INVENTION

1. Field of the Invention

The present invention relates to convertible or folding roofs for vehicles.

2. Background Art

DE 101 16 094 C2 describes a vehicle having a convertible roof. A roof kinematic system connects the roof to the vehicle to move the roof between a closed end position in which the roof covers the vehicle interior and a stored end position in which the roof is folded and stored in a storage compartment of the vehicle. A transmission kinematic system acts upon a guide rod of the roof kinematic system in each end position with a force in the direction of the other end position. As such, forces required for lifting the roof from an end position are reduced and the roof decelerates as it reaches the other end position. This advantage achieved by the transmission kinematic system lies in the use of a relatively small actuator for the adjustment motion of the roof.

The transmission kinematic system includes a crossbar and a lever. An actuator acts on the crossbar. The lever is articulately connected at one end to the crossbar and at its other end to the guide rod of the roof kinematic system. In each end position, an optimal leverage ratio for conversion of the driving torque for lifting the roof is obtained by the lever and the guide rod. However, the transmission kinematic system has a relatively complicated design.

### SUMMARY OF THE INVENTION

An object of the present invention is to lift a movable roof part from at least one end position of the roof with a low expenditure of force either manually or by an actuator having small dimensions.

In carrying out the above object and other objects, the present invention provides a vehicle having a roof, a roof part kinematic system, and a transmission kinematic system. The roof has roof parts movably connected together such that the roof parts are movable between a closed position of the roof in which the roof parts cover the vehicle interior and a stored position of the roof in which the roof parts expose the vehicle interior. The roof part kinematic system includes a guide rod pivotably supported at one end about a vehicle body-side rotary joint and pivotably supported at another end to one of the roof parts to movably connect the roof part to the vehicle body such that upon actuation of the guide rod the roof part kinematic system moves the roof part between the closed and stored positions of the roof. The transmission kinematic system has a spring and a displaceable tensioning lever. The spring is connected at one end to the guide rod and is connected at another end to the tensioning lever. When the spring is pretensioned the spring acts upon the guide rod with a swivel torque about the rotary joint of the guide rod to actuate the guide rod for the roof part kinematic system to move the roof part between the closed and stored positions of the roof. The tensioning lever places the spring under pretension upon being displaced.

Also, in carrying out the above object and other objects, the present invention provides a movable roof assembly for a vehicle. The roof assembly includes a roof, a roof part kinematic system, and a transmission kinematic system. The roof includes roof parts movably connected together such that the roof parts are movable between a first end position and a second end position. The roof part kinematic system has a guide rod pivotably supported at one end about a rotary joint and pivotably supported at another end to one of the roof parts such that upon actuation of the guide rod the roof part kinematic system moves the roof part between the end positions. The transmission kinematic system having a spring and a displaceable tensioning lever. The spring is connected at one end to the guide rod and is connected at another end to the tensioning lever. When the spring is pretensioned the spring acts upon the guide rod with a swivel torque about the rotary joint of the guide rod to actuate the guide rod for the roof part kinematic system to move the roof part between the end positions. The tensioning lever places the spring under pretension upon being displaced.

In an embodiment of the present invention, a roof assembly for a vehicle includes a roof having a roof part, a roof part kinematic system, and a transmission kinematic system. The roof part kinematic system movably connects the roof part to the vehicle body for moving the roof part between a closed position (i.e., an end position) of the roof in which the roof covers the vehicle interior and a stored position (i.e., another end position) of the roof in which the roof is stored within a rear storage compartment of the vehicle. The transmission kinematic system includes a spring and a displaceable tensioning lever. One end of the spring engages a pivotably supported roof guide rod of the roof part kinematic system and acts upon the roof guide rod with a swivel torque about a rotary joint thereof. The other end of the spring is supported on the tensioning lever. When actuated, the tensioning lever places the spring under pretension. The pretension of the spring generates a torque which lifts the roof part from an end position. The generated torque has an optionally selected magnitude such that the roof part is lifted from the end position without further effort. The energy required for transporting the roof part from one end position to the opposite end position is stored in the pretension of the spring.

This design has various advantages. The spring may be tensioned independently from the motion of the roof part thereby supplying the spring with the energy required for the lifting motion. The motion of the roof part and the tensioning of the spring are decoupled from one another. As such, the tensioning process may take place after the transporting motion is completed and after the roof part has reached the end position, i.e., between two roof part actuations. As the tensioning process occurs when the roof part is stationary and not during the roof motion, this process is not time-critical and may be carried out using a small actuator or by manual actuation of the tensioning lever. The overall space requirements are reduced since smaller actuators may be used. Simply designed and inexpensive actuators may be used as the duration of the tensioning process plays a secondary role. For example, a small motor having a high spindle transmission ratio or a transporting kinematic system may be used.

In an embodiment of the present invention, the lifting of the roof part from one end position in the direction of the other end position is enabled by the same spring in both end positions. That is, this lifting is enabled by the same spring in the closed position as well as the stored position of the roof. In an intermediate position of the roof part such as the peak position of the roof part as the roof part is moving from one end position to the other end position, the direction of action (i.e., the orientation) of the spring on the roof part kinematic system reverses. In the case of a linear, translationally acting spring, this is achieved because the action direction of the spring traverses the position of the rotary joint via which the roof guide rod, with which the spring engages at a distance from the rotary joint, is pivotably supported. To achieve this traversal motion of the action direction of the spring, the base of the spring rests at a distance from the rotary joint of the roof guide rod and during the rotational motion of the roof guide rod the action direction of the spring extends between the spring base and the engagement point of the spring on the roof guide rod and crosses over the rotational axis thereby reversing the direction of action of the spring. Due to the mounting on the tensioning lever the base of the spring remains in a constant position during the entire transporting motion and is not displaced until the transporting motion resulting from actuation of the tensioning lever is completed.

After reaching the opposite end position, the base of the spring is displaced via an actuation-manually or by a motor of the tensioning lever. This displacement motion of the base of the spring is accompanied by tensioning of the spring. The elastic force may also be maintained over a longer time period as the tensioning lever causes a mechanical blockage of the spring. As soon as locking mechanisms securing the roof part in a respective end position are released, as a result of the action of the tensioned spring the roof part begins its transporting motion in the direction of the other end position.

Because of the reversal of the direction of action of the spring in an intermediate position of the roof part during the transporting motion, the approach motion of the roof part to the opposite end position occurs against the action of elastic force thereby causing the motion of the roof part to decelerate as the target end position is approached. However, on account of the leverage ratio which is becoming less favorable, this decelerating force is smaller than the lifting force at the beginning of the transporting motion. However, upon re-tensioning when the target end position is reached a better leverage ratio is reestablished and the spring is tensioned, so that the torque generated by the elastic force is sufficient for lifting from the achieved end position to the other end position.

In an embodiment of the present invention, the roof part kinematic system includes a four-bar kinematic linkage having two roof guide rods. Each roof guide rod is pivotably supported at one end to the vehicle body. Each roof guide rod is pivotably supported at its other end to the roof part. The spring may be a compression spring which is positioned such that the pressure force causes the roof part to lift from the respective end position. The spring may also be a tension spring or a torsion spring.

The above features, and other features and advantages of the present invention as readily apparent from the following detailed descriptions thereof when taken in connection with the accompanying drawings.

### BRIEF DESCRIPTION OF THE DRAWINGS

FIG. 1 illustrates a perspective view of a vehicle roof having front and rear roof parts movable between a closed position in which the roof parts cover the vehicle interior and a stored position in which the roof parts are stored within a rear storage compartment of the vehicle in accordance with an embodiment of the present invention with the roof being in the closed position;

FIG. 2 illustrates a roof part kinematic system movably connecting the front roof part to the vehicle body and a transmission kinematic system movably connecting the roof part kinematic system to the vehicle body in accordance with an embodiment of the present invention with the roof being in the closed position;

FIG. 3 illustrates the front roof part, the roof part kinematic system, and the transmission kinematic system at an intermediate position between the closed and stored positions of the roof during transfer of the roof from the closed position to the stored position;

FIG. 4 illustrates the front roof part, the roof part kinematic system, and the transmission kinematic system at the stored position of the roof after transfer of the roof from the closed position to the stored position;

FIG. 5 illustrates the front roof part, the roof part kinematic system, and the transmission kinematic system at the stored position of the roof with a tensioning lever of the transmission kinematic system being actuated for tensioning a spring of the transmission kinematic system in accordance with an embodiment of the present invention;

FIG. 6 illustrates the front roof part, the roof part kinematic system, and the transmission kinematic system at an intermediate position between the closed and stored positions of the roof during transfer of the roof from the stored position to the closed position; and

FIG. 7 illustrates the front roof part, the roof part kinematic system, and the transmission kinematic system at the closed position of the roof after transfer of the roof from the stored position to the closed position.

### DETAILED DESCRIPTION OF THE PREFERRED EMBODIMENT(S)

Identical components have the same reference numerals in the figures.

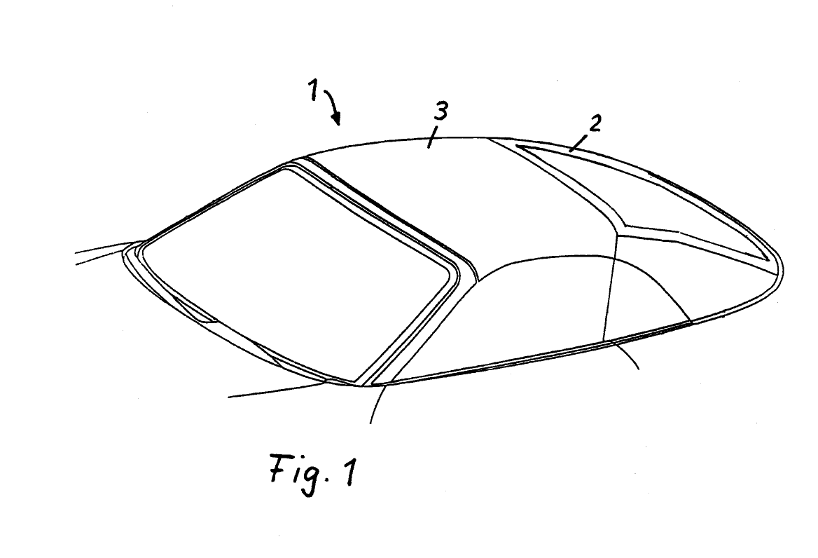

Referring now to FIG. 1, a perspective view of a roof 1 for a vehicle in accordance with an embodiment of the present invention is shown. Roof 1 is a two-part hardtop including a rear roof part 2 and a front roof part 3. Roof parts 2, 3 are movable between a closed position in which roof parts 2, 3 cover the vehicle interior and a stored position in which roof parts 2, 3 are folded on top of one another and stored within a rear storage compartment of the vehicle. Rear roof part 2 includes a rear window integrated therein. In accordance with other embodiments of the present invention, roof 1 is a soft-top having a fabric cover on an adjustable folding top linkage.

FIG. 1 illustrates roof 1 in its closed position. In the closed position of roof 1, roof parts 2, 3 extend between the windshield frame at the front end of the vehicle and a trunk lid at the rear end of the vehicle. The trunk lid covers a storage compartment at the rear end of the vehicle. Roof parts 2, 3 are folded and moved into the storage compartment for storage therein in the stored position of roof 1.

A roof kinematic system having kinematic linkages respectively associated with roof parts 2, 3 movably connect roof parts 2, 3 to the vehicle body to move roof parts 2, 3 between the closed and stored positions of roof 1. The kinematic linkages are actuated to move roof parts 2, 3 between the closed and stored positions of roof 1. The kinematic linkages ensure an unambiguously kinematically determined transporting motion of roof parts 2, 3 between the closed and stored positions of roof 1.

Referring now to FIGS. 2, 3, 4, 5, 6, and 7, with continual reference to FIG. 1, a roof part kinematic system 6 movably connecting front roof part 3 to vehicle body 13 and a transmission kinematic system 9 movably connecting roof part kinematic system 6 to vehicle body 13 in accordance with an embodiment of the present invention is shown. The end positions of roof 1 (i.e., the closed and stored positions of roof 1) are symbolically represented by end stops 4 and 5 in which end stop 4 corresponds to the closed roof position and end stop 5 corresponds to the stored roof position.

FIGS. 2, 3, 4, 5, 6, and 7 illustrate an embodiment of the present invention with reference to front roof part 3. Other embodiments of the present invention are with reference to rear roof part 2 and/or front roof part 3.

FIG. 2 illustrates front roof part 3, roof part kinematic system 6, and transmission kinematic system 9 at the closed position of roof 1. Roof part kinematic system 6 movably connects roof part 3 to vehicle body 13 such that roof part 3 is movable between the closed and stored positions of roof 1. Roof part kinematic system 6 is a four-bar kinematic linkage having first and second roof guide rods 7 and 8. Guide rod 7 is pivotably connected at one end to vehicle body 13 via a body-side rotary joint 7a and is pivotably connected at its other end to roof part 3 via a rotary joint 7b. Similarly, guide rod 8 is pivotably connected at one end to vehicle body 13 via a body-side rotary joint 8a and is pivotably connected at its other end to roof part 3 via a rotary joint 8b.

Transmission kinematic system 9 is associated with roof part kinematic system 6. Transmission kinematic system 9 includes a spring 10 and a tensioning lever 11. Transmission kinematic system 9 acts on guide rod 7 to move roof kinematic system 6 to thereby move roof part 3 between the closed and stored positions of roof 1. For this purpose, spring 10 engages an extension 12 fixedly mounted on guide rod 7. The oppositely situated base of spring 10 is pivotably connected to one end of tensioning lever 11. The other end of tensioning lever 11 is rotatably attached to vehicle body 13 via a body-side rotary joint 11a.

Spring 10 is a compression spring. Spring 10 is in its pre-tensioned position at the closed position of roof 1. In its pre-tensioned position, spring 10 exerts a large pressure force between its base and the engagement point at extension 12 of guide rod 7. As spring 10 has an orientation 14 passing through the engagement point at extension 12 of guide rod 7 and the base of the spring is situated at a distance from body-side rotary joint 7a to which guide rod 7 is rotatably connected, the pressure force of spring 10 generates an effective torque in the clockwise direction about the axis of rotary joint 7a. This torque tends to lift roof part 3 from the closed position of roof 1 and transfer roof part 3 toward the stored position of roof 1. The pre-tensioning force in spring 10 is selected to be high enough so that after unlocking, roof part 3 is automatically transported due to the action of spring 10 from one end position (such as closed position 4) to the opposite end position (such as stored position 5) against the intrinsic weight of roof part 3.

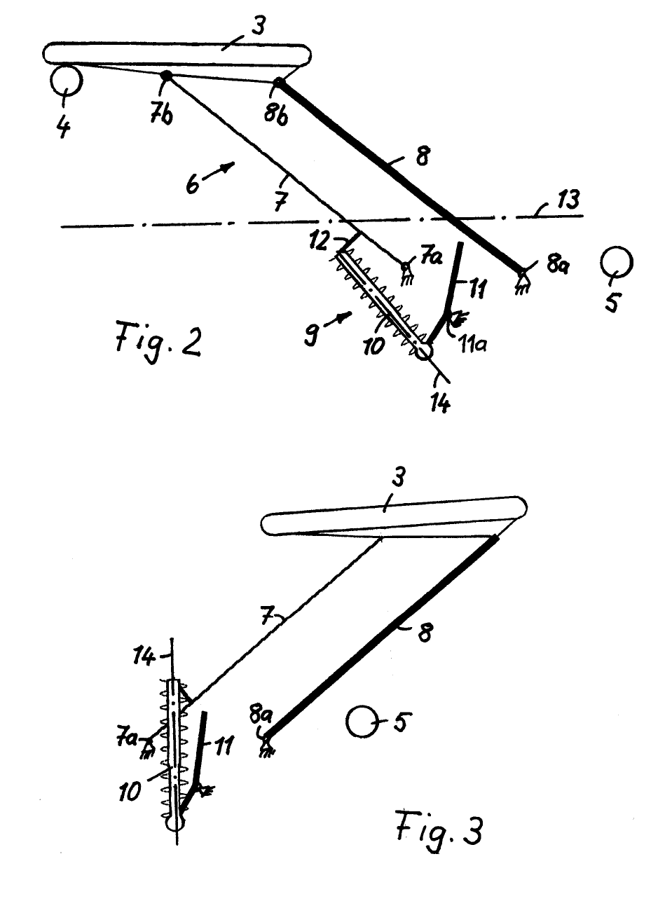

FIG. 3 illustrates front roof part 3, roof part kinematic system 6, and transmission kinematic system 9 at a first intermediate position between the closed and stored positions of roof 1 during transfer of roof 1 from the closed position to the stored position. Orientation (i.e., line of action) 14 of spring 10 in the closed position of roof 1 is situated on the near side of body-side rotary joint 7a as shown in FIG. 2 whereas orientation 14 of spring 10 in the first intermediate position is on the far side of rotary joint 7a as shown in FIG. 3. In other words, orientation 14 of spring 10 in the first intermediate position has past beyond the position of rotary joint 7a. Roof part 3 is raised to a maximum raised position (i.e., a peak position) when orientation 14 of spring 10 corresponds to the position of rotary joint 7a. When this peak position is passed, the weight of roof part 3 pushes roof part 3 in the direction of stored position 5 and, as a result, orientation 14 of spring 10 passes beyond rotary joint 7a (as shown in FIG. 3) such that the direction of action of the elastic force on roof part 3 reverses. An initial action in the direction of stored position 5 then becomes an action opposing the storing motion in the direction of closed position 4. On account of the leverage ratio becoming less favorable the effective torque about rotary joint 7a which then acts going into closed position 4 is less than in the direction of the torque working in stored position 5 and which is generated by weight force, so that the storing motion continues, although in a decelerated manner.

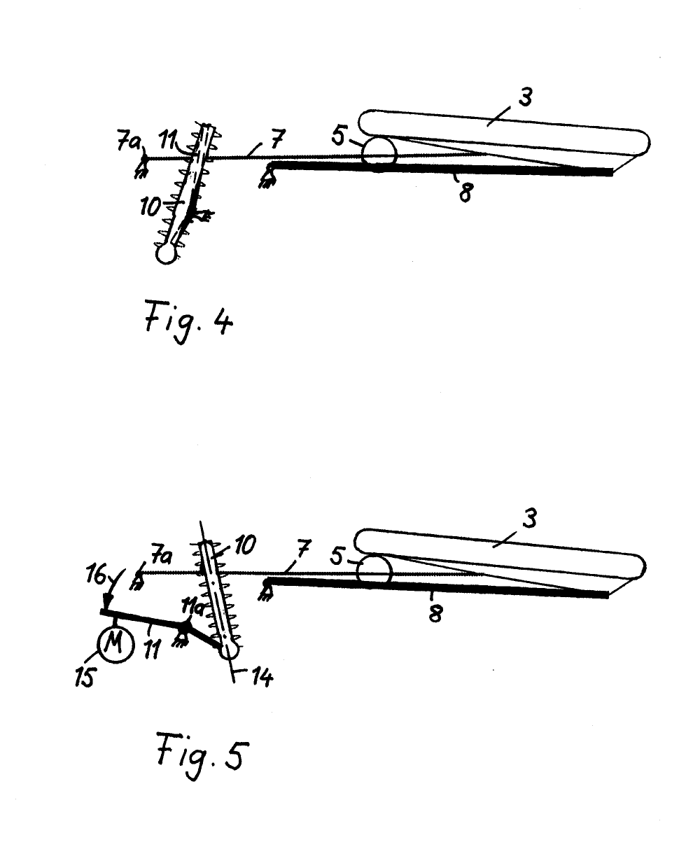

FIG. 4 illustrates front roof part 3, roof part kinematic system 6, and transmission kinematic system 9 at the stored position of roof 1 after transfer of roof 1 from the closed position to the stored position. Roof part 3 has reached stored position 5. Spring 10 is in a partially relaxed position being relatively little pre-tensioned.

FIG. 5 illustrates front roof part 3, roof part kinematic system 6, and transmission kinematic system 9 at the stored position of roof 1 with tensioning lever 11 being actuated for tensioning spring 10. An actuator 15 displaces tensioning lever 11 to actuate tensioning lever 11 in order to increase the pretension in spring 10 until transport of roof part 3 from stored position 5 to closed position 4 is possible due to the action of spring 10. During the storing motion of roof 1 from the closed position to the stored position of roof 1 as illustrated in FIGS. 2, 3, and 4, the position of tensioning lever 11 remains unchanged with respect to vehicle body 13. As a result of actuation by actuator 15, in stored position 5 tensioning lever 11 swivels about its body-side rotary joint 11a in the direction of arrow 16 thereby displacing the base of spring 10 and greatly increasing the pretension in spring 10. At the same time, due to the displacement of the base of spring 10, orientation 14 of spring 10 shifts such that the leverage ratio is improved with respect to the effective torque about body-side rotary joint 7a. In conjunction with the pretension, after roof part 3 lock is released this is sufficient to lift roof part 3 from stored position 5 against its intrinsic weight and transport roof part 3 to closed position 4.

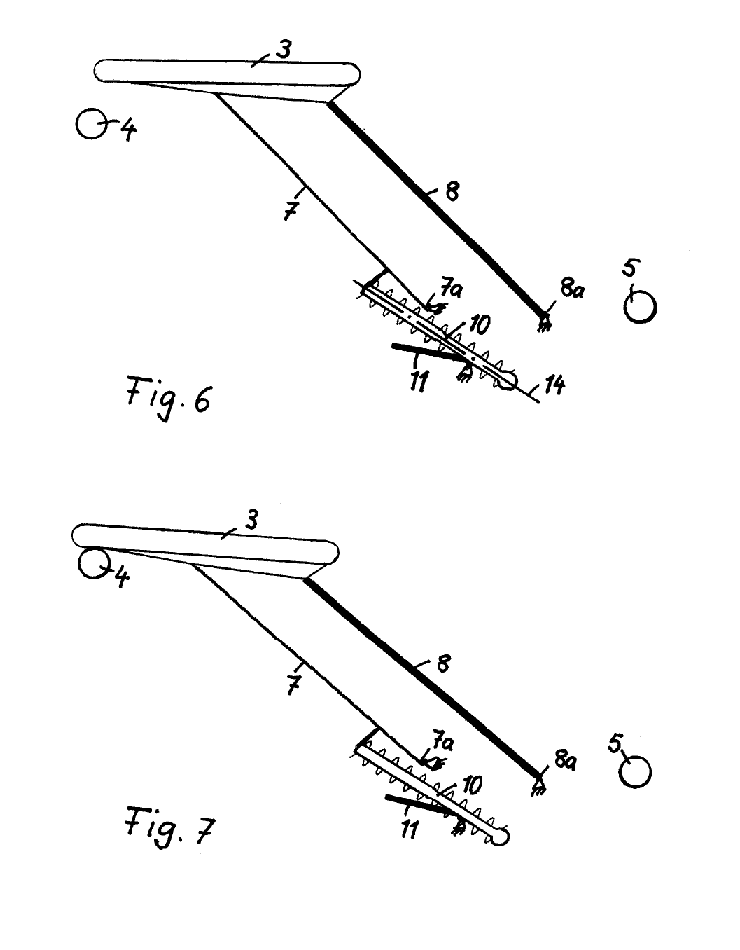

FIG. 6 illustrates front roof part 3, roof part kinematic system 6, and transmission kinematic system 9 at a second intermediate position between the closed and stored positions of roof 1 during transfer of roof 1 from stored position 5 to closed position 4. The second intermediate position is shortly before roof part 3 reaches closed position 4. Orientation 14 of spring 10 has passed body-side rotary joint 7a so that orientation 14 of spring 10 is reversed. Spring 10 then has a decelerating effect on roof part 3 as roof part 3 approaches closed position 4.

FIG. 7 illustrates front roof part 3, roof part kinematic system 6, and transmission kinematic system 9 at the closed position of roof 1 after transfer of roof 1 from stored position 5 to closed position 4. Spring 10 is in a partially relaxed state. During the overall closing motion of roof part 3 the position of tensioning lever 11 remains unchanged with respect to vehicle body 13. In order to re-tension spring 10 and to improve the leverage ratio, tensioning lever 11 must be swiveled again about body-side rotary joint 11a via actuation by actuator 15.

Actuator 15 for moving tensioning lever 11 about body-side rotary joint 11a is an electric motor. Hydraulic control parts may also be used.

An actuator may be omitted. In this case, the pre-tensioning force is manually applied via an actuation of tensioning lever 11. In addition, the base of spring 10 may be guided in a sliding part or an oblong hole with the displacement motion being carried out manually or by a motor. The sliding part or oblong hole has a linear design, although curved designs may be used to realize curved paths.

In another embodiment of the present invention, an additional actuator acting directly on roof part kinematic system 6 may be provided to carry out a controlled motion of roof 1 which can be stopped at any time. This actuator, which also performs the function of an active decelerating part, is for example an electric motor having a self-locking transmission. This actuator does not have to produce drive power, but instead fulfills a control function for canceling the self-locking as the drive power is essentially produced via spring 10.

### LIST OF REFERENCE NUMERALS

1 Vehicle roof
2 Rear roof part
3 Front roof part
4 Closed roof position
5 Stored roof position
6 Roof part kinematic system
7 First roof guide rod
7a, b Rotary joints
8 Second roof guide rod
8a, b Rotary joints
9 Transmission kinematic system
10 Spring
11 Tensioning lever
11a Rotary joint
12 Extension
13 Vehicle body
14 Spring orientation (direction of spring action)
15 Actuator
16 Arrow direction

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A vehicle comprising:
a roof having a plurality of roof parts movably connected together such that the roof parts are movable between a closed position of the roof in which the roof parts cover the vehicle interior and a stored position of the roof in which the roof parts expose the vehicle interior;
a roof part kinematic system having a guide rod pivotably supported at one end about a vehicle body-side rotary joint and pivotably supported at another end to one of the roof parts to movably connect the roof part to the vehicle body such that upon actuation of the guide rod the roof part kinematic system moves the roof part between the closed and stored positions of the roof; and
a transmission kinematic system having a spring and a displaceable tensioning lever, wherein the spring is connected at one end to the guide rod and is connected at another end to the tensioning lever, wherein when the spring is pretensioned the spring acts upon the guide rod with a swivel torque about the rotary joint of the guide rod to actuate the guide rod for the roof part kinematic system to move the roof part between the closed and stored positions of the roof, wherein the tensioning lever places the spring under pretension upon being displaced.

2. The vehicle of claim 1 wherein:
the tensioning lever is displaced independently of the motion of the roof part between the closed and stored positions of the roof.

3. The vehicle of claim 1 further comprising:
an actuator for displacing the tensioning lever.

4. The vehicle of claim 3 wherein:
the actuator is an electric motor having a self-locking transmission.

5. The vehicle of claim 1 wherein:
the tensioning lever is pivotably supported at one end about another vehicle body-side rotary joint.

6. The vehicle of claim 1 wherein:
the base of the spring is guided in a sliding part or an oblong hole.

7. The vehicle of claim 1 wherein:
the orientation of the spring crosses over the position of the rotary joint of the guide rod during transport of the roof part between the closed and stored positions.

8. The vehicle of claim 1 wherein:
the pretension of the spring exceeds the weight of the roof part and the roof part kinematic system.

9. The vehicle of claim 1 wherein:
the roof part kinematic system includes a four-bar kinematic linkage having the guide rod and a second guide rod, wherein each guide rod is pivotably supported on the vehicle body at one end and is pivotably supported on the roof part at another end.

10. The vehicle of claim 1 wherein:
the spring is a compression spring.

11. The vehicle of claim 1 wherein:
the spring is a tension spring.

12. A movable roof assembly for a vehicle, the roof assembly comprising:
a roof having a plurality of roof parts movably connected together such that the roof parts are movable between a first end position and a second end position;
a roof part kinematic system having a guide rod pivotably supported at one end about a rotary joint and pivotably supported at another end to one of the roof parts such that upon actuation of the guide rod the roof part kinematic system moves the roof part between the end positions; and
a transmission kinematic system having a spring and a displaceable tensioning lever, wherein the spring is connected at one end to the guide rod and is connected at another end to the tensioning lever, wherein when the spring is pretensioned the spring acts upon the guide rod with a swivel torque about the rotary joint of the guide rod to actuate the guide rod for the roof part kinematic system to move the roof part between the end positions, wherein the tensioning lever places the spring under pretension upon being displaced.

13. The roof assembly of claim 12 wherein:
the tensioning lever is displaced independently of the motion of the roof part between the end positions.

14. The roof assembly of claim 12 further comprising:
an actuator for displacing the tensioning lever.

15. The roof assembly of claim 14 wherein:
the actuator is an electric motor having a self-locking transmission.

16. The roof assembly of claim 12 wherein:
the tensioning lever is pivotably supported at one end about another rotary joint.

17. The roof assembly of claim 12 wherein:
the base of the spring is guided in a sliding part or an oblong hole.

18. The roof assembly of claim 12 wherein:
the orientation of the spring crosses over the position of the rotary joint of the guide rod during transport of the roof part between the end positions.

19. The roof assembly of claim 12 wherein:
the pretension of the spring exceeds the weight of the roof part and the roof part kinematic system.

20. The roof assembly of claim 12 wherein:
the roof part kinematic system includes a four-bar kinematic linkage having the guide rod and a second guide rod, wherein each guide rod is pivotably supported at one end and is pivotably supported on the roof part at another end.
